(19) United States
(12) Patent Application Publication
(10) Pub. No.: US 2012/0131081 A1
(43) Pub. Date: May 24, 2012

(54) Hybrid Fast Fourier Transform

(75) Inventor: Eric David Postpischil, Merrimack, NH (US)

(73) Assignee: APPLE INC., Cupertino, CA (US)

(21) Appl. No.: 12/952,071

(22) Filed: Nov. 22, 2010

(51) Int. Cl. G06F 17/14

(52) U.S. Cl. 708/404

(57) ABSTRACT

A hybrid fast Fourier transform (FFT) combines a prime-factor algorithm (PFA) with a Cooley-Tukey algorithm (CTA). The combining includes performing combined permutations and combined weight multiplications during CTA processing using permutations and weights derived from the PFA processing and the CTA processing to improve efficiency. The combined permutations can include the last permutation of the PFA processing combined with the first permutation of the CTA processing. The combined weights can include multiplying weights resulting from a permutation that was omitted during PFA processing by “twiddle” factors generated during CTA processing. The combined weights can be pre-computed and stored in table where they can be applied during CTA processing.

### TECHNICAL FIELD

This disclosure relates generally to discrete Fourier transform (DFT) formulations.

### BACKGROUND

The DFT is a mathematical transform widely employed in signal processing and related fields to analyze the frequencies contained in a sampled signal, to solve partial differential equations, and to perform other operations such as convolutions or multiplying large integers. The input to the DFT is a finite sequence of real or complex numbers, making the DFT ideal for processing information stored in computers using single input, multiple data (SIMD) processing.

In practice, the DFT can be computed efficiently using a fast Fourier transform (FFT) algorithm. The Cooley-Tukey algorithm (CTA) is the most common FFT algorithm. It re-expresses the DFT of an arbitrary composite size N=N₁N₂ in terms of smaller DFTs of sizes N₁ and N₂, recursively, to reduce computation time.

Another popular FFT algorithm is the prime-factor algorithm (PFA). The PFA is an FFT algorithm that re-expresses the DFT of a vector of size N=N₁*N₂ as a two-dimensional N₁×N₂ DFT, where N₁ and N₂ are relatively prime. The smaller transforms of size N₁ and N₂ can be evaluated by applying the PFA recursively to reduce computation time.

### SUMMARY

A hybrid fast Fourier transform (FFT) combines a prime-factor algorithm (PFA) with a Cooley-Tukey algorithm (CTA). The combining includes performing combined permutations and combined weight multiplications during CTA processing using permutations and weights derived from the PFA processing and the CTA processing to improve efficiency. The combined permutations can include the last permutation of the PFA processing combined with the first permutation of the CTA processing. The combined weights can include multiplying weights resulting from a permutation that was omitted during PFA processing by “twiddle” factors generated during CTA processing. The combined weights can be pre-computed and stored in table where they can be applied during CTA processing.

The details of one or more implementations of a hybrid FFT is set forth in the accompanying drawings and the description below. Other features, aspects, and advantages of the hybrid FFT will become apparent from the description, the drawings, and the claims.

### BRIEF DESCRIPTION OF THE DRAWINGS

FIGS. 1A and 1B is a flow diagram of an exemplary hybrid FFT.

FIG. 2 is a flow diagram of an exemplary hybrid FFT process.

FIG. 3 is a block diagram of an exemplary hardware architecture for implementing the hybrid FFT described in reference to FIGS. 1 and 2.

Like reference symbols in the various drawings indicate like elements.

### DETAILED DESCRIPTION

This application refers to the CTA algorithm and the PFA algorithm. These algorithms are well-known and described in publicly available textbooks and articles. This specification assumes that the reader has a basic understanding of the CTA and the PFA.

Because the CTA breaks the DFT into smaller DFTs, it can be combined with the PFA for the DFT, so that the PFA can be exploited for greater efficiency in separating out relatively prime factors. The PFA has an advantage over CTA because it does not have “twiddle” factors. The hybrid FFT described below combines the PFA and the CTA to provide a more efficient DFT.

### Hybrid FFT Overview

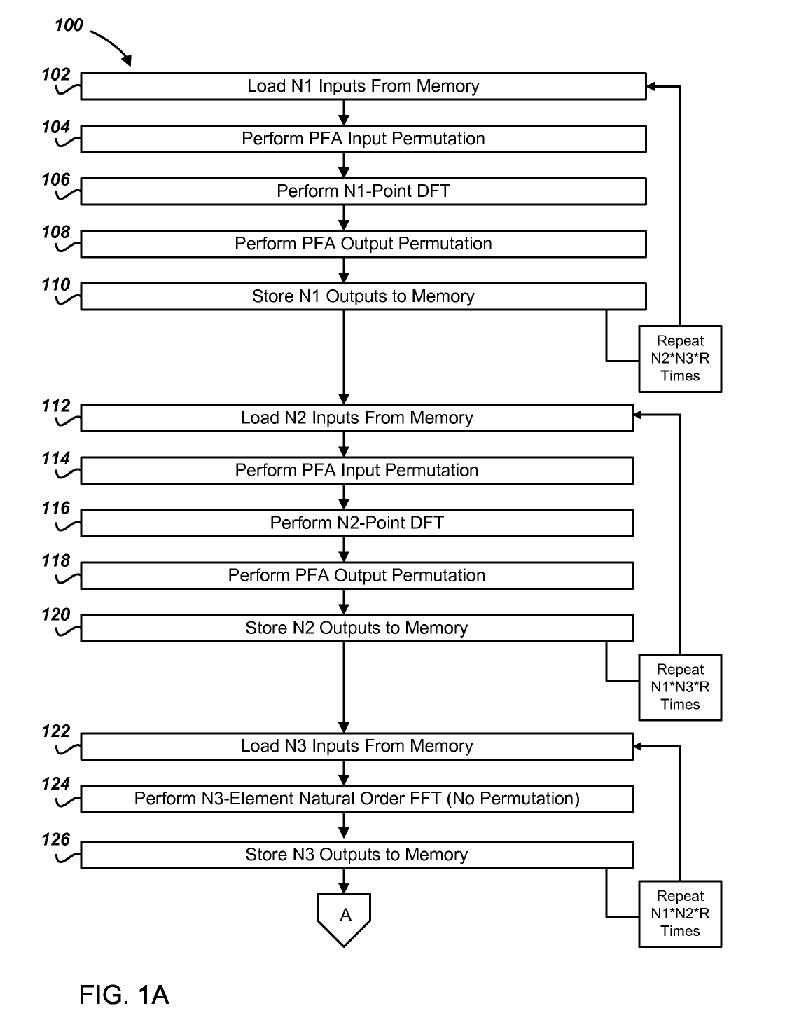

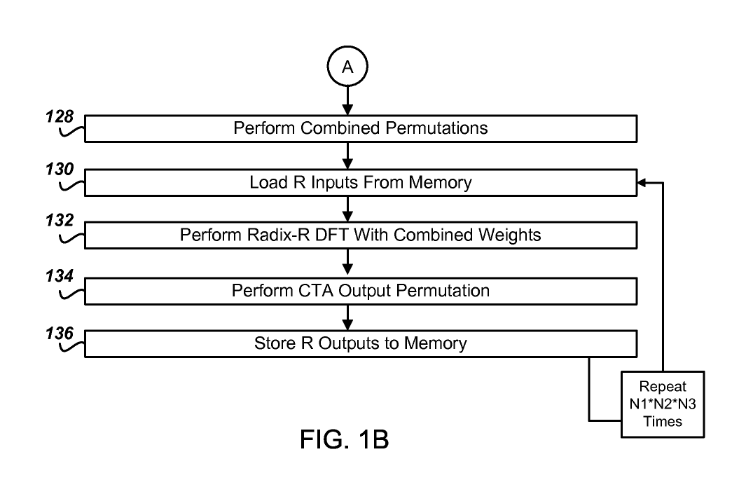

FIGS. 1A and 1B is a flow diagram of an exemplary hybrid FFT 100. In some implementations, hybrid FFT 100 can begin by factorizing a DFT into a number of factors, some of which can be relatively prime factors and some of which can be repeating factors. Hybrid FFT 100 is a based on a combination of the PFA and the CTA.

Generally, a DFT of size N can be factorized in M factors, such that

$${\prod }_{i = 1}^{M} {N}_{i} = N .$$

In the example shown, M=3, such that N=N₁N₂N₃ where N₁ and N₂ are relatively prime factors (e.g., 3 and 5) and N₃ is a repeating factor (e.g., 2″).

Process 100 can begin by loading N₁ inputs from memory (102). A PFA input permutation can be performed on the N₁ inputs for an N₁-point DFT (104). The input permutation produces its output with index i from its input with index i-b*r, where r is a function of the factors N₁, N₂, N₃, and b is a function of the current iteration. For example, steps 102-110 are performed N₂N₃R times; b is 0 the first R times, 1 the next R times, then 2, and so on. The parameter r is the multiplicative inverse of N/N₁ modulo N₁. All arithmetic is performed modulo N₁. For example, suppose N₁ is 5, b is 2, and r is 3. Then output 0 comes from input 0−2*3=−6=4, output 1 comes from 1−2*3=−5=0, output 2 comes from 2−2*3=−4=1, output 3 comes from 3-2*3=−3=2, and output 4 comes from 4−2*3=−2=3. Thus if the inputs are [A, B, C, D, E], the outputs are [E, A, B, C, D]. Note that the PFA input permutation is a translation that rotates the elements by moving each element by the same amount.

After the input permutation, an N₁-point DFT can be performed (106). A PFA output permutation is performed for the N₁-point DFT (108) and the N₁ outputs are stored in memory (110). The output permutation sends its input with index i to the output with index (i-b)*r, where b and r are as above. Following the example above, input 0 goes to output (0−2)*3=−6=4, input 1 goes to output (1−2)*3=−3=2, input 2 goes to output (2−2)*3=0, input 3 goes to output (3−2)*3=3, and input 4 goes to output (4−2)*3=6=1. Thus if the inputs are [E, A, B, C, D], the outputs are [B, D, A, C, E]. The steps 102-110 are repeated N₂N₃R times. Several iterations of steps 102-110 can be performed at the same time using SIMD because each R iterations of steps 104-110 use the same input and output permutations.

A second PFA DFT includes loading N₂ inputs from memory (112). A PFA input permutation can be performed on the N₂ inputs for an N₂-point DFT (114). The input permutation can be the same as step 104, except that r is the multiplicative inverse of N/N₂ modulo N₂. After the input permutation, an N₂-point DFT can be performed (116). A PFA output permutation is performed for the N₂-point DFT (118) and the N₂ outputs are stored in memory (120). The output permutation can be the same as performed in step 108, except with a different r. The steps 112-120 are repeated N₁N₃R times. Several iterations of steps 114-120 can be performed at the same time using SIMD. In some implementations, steps 112-120 can be performed as “in place” operations on the data to avoid additional memory allocations.

A third DFT includes loading N₃ inputs from memory (122). After the data is loaded, an N₃-point natural-order FFT can be performed (124) and the N₃ outputs are stored in memory (126). A natural-order FFT is an FFT that does not perform a bit-reversal output permutation. The steps 122-126 are repeated N₁N₂R times. Several iterations of steps 122-126 can be performed at the same time using SIMD. In some implementations, steps 122-126 can be performed as “in place” operations on the data to avoid additional memory allocations.

A combined output permutation is performed (128). The permutation is a combination of the bit-reversal permutations for the N₁N₂R N₃-element FFTs, the PFA output permutations for the N₁N₂R N₃-element FFTs, and a permutation (which is a transposition) for the CTA.

A radix-R CTA DFT includes loading R inputs from memory (130). After the data is loaded, a radix-R CTA DFT can be performed (132). The CTA DFT is performed using a combination of replacement weights for replacing the input permutation for the N₃-point PFA DFT (See expression [1] below) with twiddle factors for the radix-R CTA DFT. These weights can be pre-computed and stored in a look up table. An output permutation is performed for the radix-R CTA DFT (134) and stored in memory (136). The output permutation is a bit-reversal permutation performed after the FFT. For example, when R is 4, it maps [A, B, C, D] to [A, C, B, D]. The steps 130-136 are repeated N₁N₂N₃ times. Several iterations of steps 130-136 can be performed at the same time using SIMD. In some implementations, steps 130-136 can be performed as “in place” operations on the data to avoid additional memory allocations.

The Load and Store steps (102, 110, 112, 120, 122, 126, 130, 136) are largely conceptual. In practice, each Load can be part of the step that follows it and each Store can be part of the step that precedes it. Note that each group of steps is working on a specific set of elements (e.g., each iteration of steps 102-110 works on N₁ elements).

The hybrid FFT 100 will now be described with an example where a vector of length N=15·2″ is to be transformed using a DFT.

### Example Hybrid FFT Process

In some implementations, a hybrid FFT processing module (e.g., software code) receives as input a vector h̅ of complex elements of length f·2″. In this example, f is 15 and n>=4. For example, a vector of length N=15·2″ can be factorized as

(3*5*2⁽ⁿ⁻²⁾)×4,

where “*” indicates the DFTs are combined with the PFA, and “x” indicates the DFTs are combined with a CTA, except that the 2″ portion of the factorization is modified and blended with the “×4” portion of the factorization. This modification includes the omission of the input permutation which would be step 123, but which is instead accomplished using weights in step 132. This modification also includes the omission of the FFT permutation that would be included in step 124 and the PFA output permutation that would be step 125, which are instead accomplished as parts of the combined permutation in step 128. The 4 at the end implies that all of the 3*5*2⁽ⁿ⁻²⁾ work has four parallel sets of data to work on, so 4-element Single Input Multiple Data (SIMD) instructions can be used. Similarly, the 3*5*2⁽ⁿ⁻²⁾ portion also includes a factor of 4, so the work for the final pass can also use SIMD instructions. The combined permutation can be performed with scalar (non-SIMD) instructions.

As described above, hybrid FFT 100 of FIG. 1 uses the CTA to divide the work into two sets of DFTs, along with a permutation between the two sets and some additional multiplications in the DFTs of the second set. The PFA is used to perform an N-element DFT with modifications. The PFA divides the work into two or more sets of DFTs, depending on the factorization of N. In this example, N is a multiple of three, five and power of two. Accordingly, a set of three-element DFTs can before performed, followed by a set of five-element DFTs, followed by a set of 2″-element DFTs.

In some implementations, the PFA can be composed of several passes. Each pass can perform a set of functions that depends on a parameter nᵢ, where nᵢ is a factor that divides N and is relatively prime to N/nᵢ, and i=1, 2, 3, . . . M. The set of functions can include three functions: (L)oad, (D)FT and (S)tore, that also depend on nᵢ. Each pass steps through the data to be transformed, loading nᵢ complex elements (L) into a memory array, performing a DFT (D) and storing nᵢ results (S) in a memory array, and continuing until the end of the data is reached.

The L and S functions can be permutations. These L, D and S functions can be computed when nᵢ is relatively prime to N/nᵢ. In particular, the L and S permutations can be performed in the process of loading and storing the data in memory for the DFT function D. However, when nᵢ is a power of two, an alternative approach described below can be used.

Assume that L is a permutation, and it is a translation of a vector h̅, which maps each element h̅[k] to h[k+j], where j is the translation amount, which can differ from iteration to iteration. The composition of a DFT applied to a translation equals an element-wise multiplication applied to the DFT. If T( h̅, j) is a translation of vector h̅ by j elements, and DFT( h̅)[k] is element k of the DFT of vector h̅, then

$$DFT ( T ( \vec{h} , j ) ) [ k ] = {e}^{\frac{2 πi k j}{N}} * DFT ( \vec{h} ) [ k ] . \qquad [ 1 ]$$

Because of the property of expression [1], the L permutation can be omitted and instead each element of the DFT output can be multiplied by

$${e}^{\frac{2 πi k j}{N}} .$$

During the CTA FFT processing, “twiddle” factors are multiplied to effect the CTA, and these multiplications can be performed at the same time the multiplications in [1] are performed. Since the “twiddle” factors for the CTA multiplications and the L-replacement weights

$$( {e}^{\frac{2 πi k j}{N}} )$$

are constants for a given vector length, they can be combined (e.g., multiplied) before performing the DFT of the CTA and stored in a look up table. Using the look up table of combined weights and “twiddle” factors results in one complex multiplication per complex element in the vector h̅ during CTA processing.

As discussed above, the PFA involves the composition of functions S, D, and L, which depend on a parameter nᵢ, and S is not easily incorporated into D when nᵢ is a power of two. When nᵢ is a power of two, D can be computed with an FFT. Several passes over the data can be performed. Each pass can compute “butterflies,” and each butterfly can include multiplications by prepared weights (or “twiddle” factors) which are constant for a given vector length, followed by a DFT. Typical butterflies are radix-4 (or 2 or 8), referring to the number of complex elements processed. After the butterflies are completed, the data in memory contains the output of the DFT, but in permuted order (e.g., a bit-reversal permutation).

Because the FFT computing D needs to finish with a permutation to effect its DFT, and because S also is a permutation, these permutations can be combined. Additionally, the CTA requires a permutation after the PFA and before the final 4-element DFTs. All three of the permutations can be combined into a single permutation. The combined permutation is the result of doing each of the permutations in order.

As discussed above, element-wise multiplications of weights are performed in the final pass of 4-element DFTs, and a permutation is performed at the end of the PFA. Because that final PFA permutation is performed before the weight multiplications, it permutes which weights correspond to which vector elements. When the weights are generated, the weights can be calculated for the post-permutation arrangement of data.

In a final pass of the CTA, one of the weights in each butterfly is one, since they have the form

$${e}^{\frac{2 πi k j}{N}} ,$$

where 0<=j<4. This observation can be used to simplify code implementing the CTA by omitting unnecessary multiplication of corresponding data by one. However, when the CTA weights are combined with the PFA weights, the weights in the butterfly may be some number other than one. In such a case, the code can be configured to multiply each data element by a weight, even though some of the weights are one.

### Exemplary Hybrid FFT Process

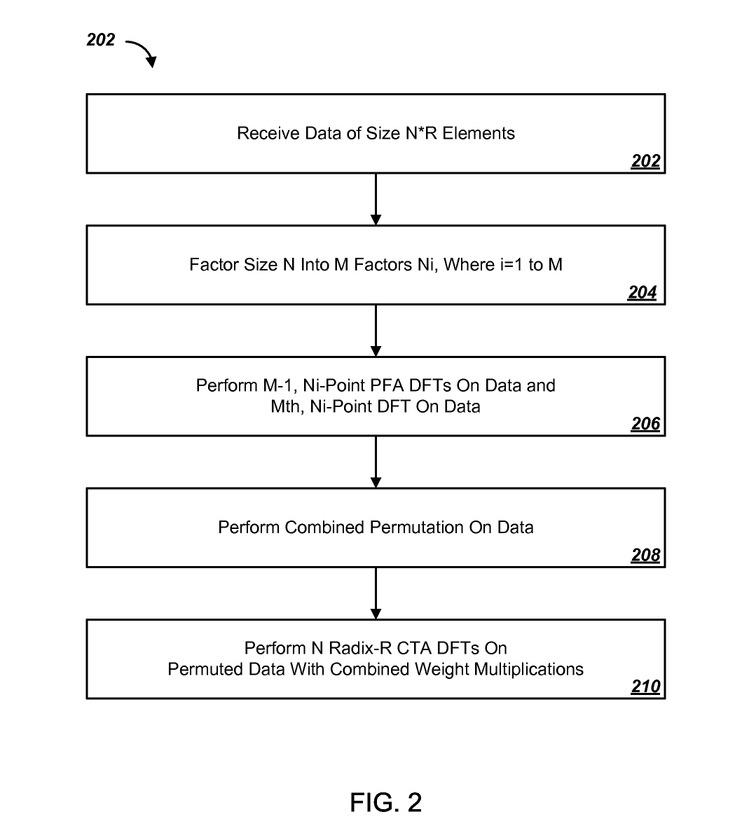

FIG. 2 is a flow diagram of an exemplary hybrid FFT process 200. The process 200 can be implemented as one or more library routines in a resource library that can be called by an application running on a computing system. The calls can be made through an Application Programming Interface (API).

In some implementations, the process 200 can begin by receiving a data vector of size N*R. For example, a data vector with N*R complex elements can be received (202). N can be factorized into M factors where i=1 to M (204). The factors can be two or more relatively prime factors and a repeating factor (204). Next, Nᵢ-point PFA DFTs can be performed on the data for the M factors, where the Mth, Nᵢ-point PFA DFT omits an input permutation and an output permutation (206). A combined permutation can be performed (208). A radix-R CTA DFT can be performed on the permuted data, including performing combined weight multiplications on the data during the radix-R CTA DFT (210). The combined weights can include weights replacing the omitted input permutation of the Mth PFA DFT according to Expression [1] with twiddle factors for the radix-R CTA DFT.

### Exemplary PFA DFT

In some implementations, the PFA DFT can be computed by computing a sequence of functions of the form:

H[k0*r0′*r0+b]=sum(1**(k0*j0*r0′/n0)*h[j0*r0′*r0+b],0<=j0<n0), [2]

where
1**x stands for e^{2πix},
j0 is the summation index,
n0 is a positive integer, such that n0 divides N (where N is a positive integer equal to the size of the vector h) and n0 is relatively prime to N/n0,
b is some multiple of n0 (such as j1*r1′*r1+ . . . +j2*r2′*r2, which is a multiple of n0 since each r1, . . . , r2 is a multiple of n0),
r0=N/n0,
r0′ is the multiplicative inverse of r0 modulo n0, and
h and H are input and output vectors, respectively, for this individual function, and not for the entire DFT.

Expression [2] can be computed in software using a composition of L(oad), S(tore) and D(FT) functions. For example, the following functions can be defined:

L(h,n0)=H, where H[a][b]=h[a−b*r0′][b],

S(h,n0)=H, where H[(a−b)*r0′][b]=h[a][b],

and

D(h,n0)=H, where H[a][b]=sum(1**(a*j/n0)*h[j][b],0<=j<n0),

where the two-dimensional references H[x][y] and h[x][y] are abbreviations for H[x*N/n0+y] and h[x*N/n0+y], respectively, and 0<=a<n0 and 0<=b<N/n0.

Software routines can compute a composition of functions S, D and L, one column at a time. The variable b is the column number. The computation can be applied to a number of parallel and independent lanes using SIMD processing (e.g., 4 lanes). For example, for 0<=b<r0:

L can be computed for 0<=a<n0 by loading data from memory addresses indexed by [a−b*r0′][b] into registers or objects enumerated from 0 to n0−1 (e.g., for n0=3, real and imaginary parts are loaded into a0r, a0i, a1r, a1i, a2r, and a2i);

D can be computed with source code and constants hard-coded for each value of n0 (e.g., 3 and 5), producing results in registers or objects again enumerated from 0 to n0−1 (e.g., c0r, c0i, . . . ); and

S can be computed by storing the results to memory addresses indexed by [(a−b)*r0′][b].

The indexing in functions L and S uses only the residue of b modulo n0 for the first subscript, since h and H are cyclic in the first dimension with period n0. This allows address arithmetic for the first dimension to be hard-coded, given values of n0 and r0′, by creating one iteration of function D for each residue of b modulo n0.

### Example Hardware Architecture

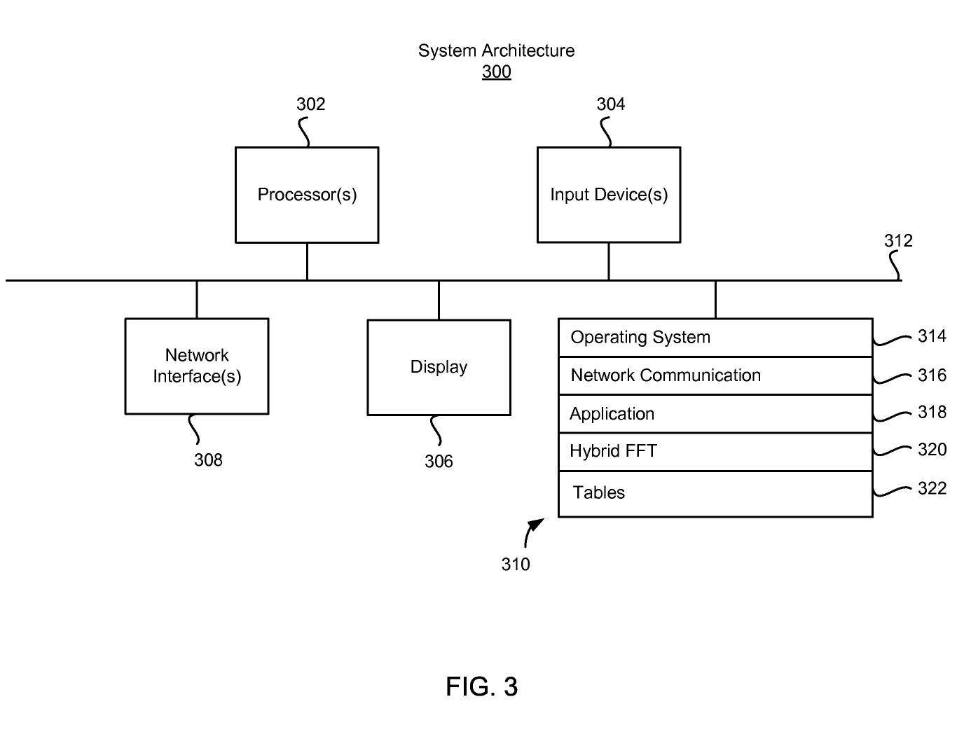

FIG. 3 is a block diagram of an exemplary hardware architecture for implementing the hybrid FFT described in reference to FIGS. 1 and 2. The architecture 300 can be implemented on any electronic device that runs software applications derived from compiled instructions, including without limitation personal computers, servers, smart phones, media players, electronic tablets, game consoles, email devices, etc. In some implementations, the architecture 300 can include one or more application processors 302, one or more input devices 304, one or more network interfaces 308, one or more display devices 306, and one or more computer-readable mediums 310. Each of these components can be coupled by bus 312.

Display device 306 can be any known display technology, including but not limited to display devices using Liquid Crystal Display (LCD) or Light Emitting Diode (LED) technology. Processor(s) 302 can be any known processor or chipset, including but not limited to single core and multi-core general purpose processors and digital signal processors having parallel processing architectures (e.g., SIMD architectures). Input device(s) 304 can be any known input device technology, including but not limited to a keyboard (including a virtual keyboard), mouse, track ball, and touch-sensitive pad or display. Bus 312 can be any known internal or external bus technology, including but not limited to ISA, EISA, PCI, PCI Express, NuBus, USB, Serial ATA or FireWire. Computer-readable medium 310 can be any medium that stores instructions for execution by processor(s) 302, including without limitation, non-volatile media (e.g., optical disks, magnetic disks, flash drives, etc.) or volatile media (e.g., SDRAM, ROM).

Computer-readable medium 310 can include various instructions 314 for implementing an operating system (e.g., Mac OS®, Windows®, Linux). The operating system can be multi-user, multiprocessing, multitasking, multithreading, real-time and the like. The operating system performs basic tasks, including but not limited to: recognizing input from input device 304; sending output to display device 306; keeping track of files and directories on computer-readable medium; controlling peripheral devices (e.g., disk drives, printers, etc.) which can be controlled directly or through an I/O controller; and managing traffic on bus 312. Network communications instructions 316 can establish and maintain network connections (e.g., software for implementing communication protocols, such as TCP/IP, HTTP, Ethernet, etc.).

Application 318 can include any application that uses the hybrid FFT 320, as described in reference to FIGS. 1 and 2. Tables 322 can be used to store pre-computed values, such as products of weights and twiddle factors, which can be applied during CTA processing.

The disclosed and other embodiments and the functional operations described in this specification can be implemented in digital electronic circuitry, or in computer software, firmware, or hardware, including the structures disclosed in this specification and their structural equivalents, or in combinations of one or more of them. The disclosed and other embodiments can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, or a combination of one or more them. An apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, the disclosed embodiments can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The disclosed embodiments can be implemented in a computing system that includes a back end component, e.g., as a data server, or that includes a middleware component, e.g., an application server, or that includes a front end component, e.g., a client computer having a graphical user interface or a Web browser through which a user can interact with an implementation of what is disclosed here, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

While this specification contains many specifics, these should not be construed as limitations on the scope of what being claims or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method comprising:
receiving a data of size N*R;
factorizing the size N into M factors;
performing M sets of discrete Fourier transforms (DFTs) using a prime-factor algorithm (PFA), where an input permutation for the Mth PFA DFT is omitted and an output permutation for the Mth PFA DFT is omitted;
performing a combined permutation, including bit-reversal permutations for Fast Fourier Transforms (FFTs), PFA output permutations, and a transposition for a Cooley-Tukey algorithm (CTA); and
performing a set of radix-R DFTs on the permuted data, including multiplying the data by combined weights, the combined weights including weights replacing the omitted input permutation of the Mth PFA DFT and weights associated with the radix-R CTA DFT,
where the method is performed by one or more computer processors.

2. The method of claim 1, where the factors include two or more relatively prime factors and a repeating factor.

3. The method of claim 1, where the combined weights can be pre-computed and stored in a table.

4. The method of claim 1, where the weights resulting from the omitted input permutation are given by
$${e}^{\frac{2 πi k j}{N}} ,$$
where k is an index into a vector storing the data, j is a translation amount and N is the number of elements in the DFT.

5. A system comprising:
one or more processors;
memory coupled to the one or more processors and including instructions, which, when executed by the one or more processors, causes the one or more processors to perform operations comprising:
receiving a data of size N*R;
factorizing the size N into M factors;
performing M sets of discrete Fourier transforms (DFTs) using a prime-factor algorithm (PFA), where an input permutation for the Mth PFA DFT is omitted and an output permutation for the Mth PFA DFT is omitted;
performing a combined permutation, including bit-reversal permutations for Fast Fourier Transforms (FFTs), PFA output permutations, and a transposition for a Cooley-Tukey algorithm (CTA); and
performing a set of radix-R DFTs on the permuted data, including multiplying the data by combined weights, the combined weights including weights replacing the omitted input permutation of the Mth PFA DFT and weights associated with the radix-R CTA DFT,
where the method is performed by one or more computer processors.

6. The system of claim 5, where the factors include two or more relatively prime factors and a repeating factor.

7. The system of claim 5, where the combined weights can be pre-computed and stored in a table.

8. The system of claim 5, where the weights resulting from the omitted input permutation are given by
$${e}^{\frac{2 πi k j}{N}} ,$$
where k is an index into a vector storing the data, j is a translation amount and N is the number of elements in the DFT.
